(19) United States
(12) Patent Application Publication
(10) Pub. No.: US 2025/0035751 A1
(43) Pub. Date: Jan. 30, 2025

(54) OPTICAL PHASED ARRAY ANTENNA FOR LIDAR COMBINED WITH OPA AND MEMS MIRROR AND LIDAR INCLUDING THE SAME

(71) Applicant: GIST(Gwangju Institute of Science and Technology), Gwangju (KR)

(72) Inventors: Nan Ei YU, Gwangju (KR); Byeong Chan PARK, Gwangju (KR)

(73) Assignee: GIST(Gwangju Institute of Science and Technology), Gwangju (KR)

(21) Appl. No.: 18/676,800

(22) Filed: May 29, 2024

(30) Foreign Application Priority Data
Jul. 24, 2023 (KR) 10-2023-0096054

(51) Int. Cl. G01S 7/481; G01S 17/42; G01S 17/89

(52) U.S. Cl. CPC G01S 7/4814; G01S 17/42; G01S 17/89

(57) ABSTRACT

Disclosed is an optical phased array antenna for a lidar that outputs output light provided from a light source to a measurement object and that receives reflective light reflecting from the measurement object, the optical phased array antenna including: a combiner configured to receive output light output from the light source or to output the reflective light; a phase modulation module configured to modulate a phase of the output light input from the combiner or the reflective light that is transmitted to the combiner; and an optical input/output unit configured to output the output light modulated by the phase modulation module or receive the reflective light reflecting from the measurement object and configured to have an antenna element waveguide to which the output light or the reflective light propagates and that extends a predetermined length.

### CROSS REFERENCE TO RELATED APPLICATION

The present application claims priority to Korean Patent Applications No. 10-2023-0096054, filed on Jul. 24, 2023, the entire contents of which are incorporated herein for all purposes by this reference.

### BACKGROUND

### Technical Field

The present disclosure relates to an optical phased array antenna for a lidar combined with an OPA and a MEMS mirror, and a lidar including the same. The present disclosure relates to an optical phased array antenna having a tapered waveguide that provides relatively high light transmittance and a low return loss, and a lidar including the optical phased array antenna.

### Description of the Related Art

A lidar sensor for autonomous vehicles obtains 3D space information by measuring the time that an incident pulse laser takes to return after reflecting from an object. A lidar is, in a broad meaning, classified into a ‘flash type’ and a ‘scanning type’ in accordance with the laser emission type. The flash type is a method of simultaneously emitting laser beams to a wide area, in which a light reception element is a 2D-array type such that a receiver also can recognize an image returning after reflecting. On the other hand, a scanning-type lidar performs point mapping a 3D space through vertical and horizontal rotation of a laser beam. Accordingly, it has low laser light source output and a simple receiver reception element structure in comparison to the flash type. An existing scanning-type lidar has a field of view of 360° by mechanical motor rotation.

However, in a fundamental mechanical lidar, the motor for rotation is heavy and a lot of power is consumed, so the mechanical lidar cannot be used for unmanned aerial vehicles requiring limited power and weight and the mechanical rotation speed does not satisfy a rotation speed required for autonomous vehicles to be driven on a highway.

An optical phased array antenna can distribute an incident laser to each another through several directional couplers and can obtain desired traveling directions of output lasers by modulating the phases of the distributed lasers.

An antenna requires higher laser output to increase the maximum measurement distance of a lidar, but a silicon waveguide having low laser threshold power and high linear and nonlinear losses is disadvantageous in comparison to a silicon nitride waveguide.

Since the magnitude of an evanescent wave of a waveguide mode increases due to a low refractive index in a silicon nitride waveguide, the silicon nitride waveguide can easily interact with an adjacent waveguide having a low propagation constant. In order to increase the limited horizontal field of view of an optical phased array antenna, the gap between antenna elements needs to be close to a half of the wavelength, but as antenna elements get close to each other, desired output phase distribution is not obtained due to cross-talk between the elements.

It is important for a lidar designed to be mounted in autonomous vehicles to normally operate without being influenced by temperature variation (−40˜85° C.) in a vehicle in terms of safety of passengers and pedestrians, so phase variation due to local heating that may be used for silicon nitride waveguide is difficult to use.

Signals that are transmitted through a waveguide are discharged to the upper end and the lower end of a chip at similar ratios due to symmetry of a vertical refractive index of a flat optical element due to a process on a wafer, the signals are difficult to have clear space directionality. Further, the signal discharged to the lower end of a chip reflects upward from the interface of the lower end and interferes with the signal discharged to the upper end, thereby generating undesired noise.

### PRIOR ART DOCUMENT

### Patent Document

(Patent Document 1) Korean Patent No. 10-1924890: Optical Phased Array Antenna and LiDAR having the same

### SUMMARY

The present disclosure has been made to solve the problems described above.

The present disclosure has been designed to develop a lidar that is light and inexpensive and can be mass-produced by replacing mechanical rotation that is generally used in the related art by developing a lidar for autonomous and unmanned aerial vehicles based on an optical phased array antenna.

Further, the present disclosure proposes an antenna structure making it possible to manufacture an optical phased array antenna with a size of millimeters without introducing new facilities only for manufacturing a lidar by using a CMOS process facility that can perform nanometer processes.

Further, the present disclosure proposes an optical phased array antenna in which a horizontal field of view of 120° can be expressed by 1200 points and a horizontal scan speed for measuring them is 100 kHz or more because the horizontal field of view of an optical phased array antenna for sensing object in the front area is 120° or more, the vertical field of view is 30° or more, and the spatial resolution is 0.1°.

Further, an objective of the present disclosure is to implement horizontal scan using an endfire waveguide structure for the horizontal direction and implement vertical scan using an MEMS mirror that is generally used as a component for the vertical direction of a CMOS in order to solve difficult problems with vertical output in the related art.

In order to achieve the objectives described above, an embodiment of the present disclosure provides an optical phased array antenna for a lidar that outputs output light provided from a light source to a measurement object and that receives reflective light reflecting from the measurement object, the optical phased array antenna including: a combiner configured to receive output light output from the light source or to output the reflective light; a phase modulation module configured to modulate a phase of the output light input from the combiner or the reflective light that is transmitted to the combiner; and an optical input/output unit configured to output the output light modulated by the phase modulation module or receive the reflective light reflecting from the measurement object and configured to have an antenna element waveguide to which the output light or the reflective light propagates and that extends a predetermined length, wherein antenna element waveguide is formed such a width of a first end connected to the phase modulator is different from a width of a second end from which the output light is output or to which the reflective light is input.

The antenna element waveguide may be formed such that the width of the second end is smaller than the width of the first end.

The antenna element waveguide may be tapered such that the width decreases from the first end to the second end.

The optical input/output unit may further include: a substrate; and a clad layer formed on the substrate and formed to surround the antenna element waveguide.

The antenna element waveguide may be formed such that a left-right width decreases from the first end to the second end.

The antenna element waveguide may have a uniform height.

The phase modulation module may include: a light distributor configured to distribute output light propagating from the combiner to a plurality of optical paths; and a phase modulator configured to modulate a phase of light distributed from the light distributor.

Meanwhile, a lidar according to the present disclosure includes: a light source; an optical phased array antenna of any one of claims 1 to 7; an optical circulator configured to output output light input through an input terminal from the light source to an output terminal connected to the optical phased array antenna and configured to output reflective light traveling back into the output terminal to a detection terminal; a light receive configured to receive reflective light output from the detection terminal; and a signal processor configured to process a signal received at the light receiver.

Further the lidar of the present disclosure may further include an optical deflector installed on an optical path of output light, which is output from the optical phased array antenna, and change an output direction of the output light.

The optical deflector may include: a mirror installed on the optical path of the output light output from the optical phased array antenna and to reflect the output light; and a rotating member configured to rotate the mirror at a predetermined angle.

The optical reflector may include a pivotable MEMS mirror.

The present disclosure is expected, in the future, to be used as a core element of an automotive lidar sensor that does not require scan and is also expected to be able to perform the function as an existing CMOS sensor that is used to obtain 3D image.

Further, since the present disclosure provides an optical phased array antenna having a tapered antenna element waveguide is provided, the present disclosure has the advantage that it is possible to provide relatively high light transmittance and a low return loss.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The above and other objectives, features and other advantages of the present disclosure will be more clearly understood from the following detailed description when taken in conjunction with the accompanying drawings, in which:

FIG. 1 is a conceptual diagram of a lidar combined with an OPA and an MEMS mirror according to the present disclosure;

FIG. 2 is a conceptual diagram of an antenna element waveguide of an optical phased array antenna for the lidar combined with an OPA and an MEMS mirror shown in FIG. 1;

FIG. 3 is a conceptual diagram of a lidar combined with an OPA and an MEMS mirror according to another embodiment of the present disclosure;

FIG. 4 is a graph showing variation of an effective refractive index due to variation of the width of an antenna element waveguide of an optical phased array antenna of the present disclosure;

FIG. 5 and FIG. 6 are graphs showing variation of a width of an antenna element waveguide of the present disclosure according to the traveling direction of output light;

FIG. 7 is a graph showing transmittance and reflectance according to the width of a second end of an antenna element waveguide of the present disclosure;

FIG. 8 is a graph showing transmittance and reflectance according to the length of an antenna element of the present disclosure;

FIG. 9 is a beam profile of output light that is output from an antenna element waveguide in the related art;

FIG. 10 is a beam profile of output light that is output from an antenna element waveguide of the present disclosure; and

FIG. 11 shows the results of analyzing the state of output light that is output from an antenna element waveguide of the related art and the state of output light that is output from an antenna element waveguide of the present disclosure.

### DETAILED DESCRIPTION

Hereafter, an optical phased array antenna for a lidar combined with an OPA and a MEMS mirror, and a lidar including the optical phased array antenna according to an embodiment of the present disclosure are described in detail with reference to the accompanying drawings. The present disclosure may be modified in various ways and implemented by various exemplary embodiments, so specific exemplary embodiments are shown in the drawings and will be described in detail herein. However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings. In the accompanying drawings, the dimensions of structures were exaggerated larger than the actual dimensions to make the present disclosure clear.

Terms used in the specification, “first”, “second”, etc., may be used to describe various components, but the components are not to be construed as being limited to the terms. The terms are used only to distinguish one component from another component. For example, the “first” component may be named the “second” component, and vice versa, without departing from the scope of the present disclosure.

The terms used herein are used only for the purpose of describing particular embodiments and are not intended to limit the present disclosure. Singular forms are intended to include plural forms unless the context clearly indicates otherwise. It will be further understood that the terms “comprises” or “have” used in this specification specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms have the same meanings as those that are understood by those who skilled in the art. It will be further understood that terms such as terms defined in common dictionaries should be interpreted as having a meaning that is consistent with their meaning in the context of this specification and the relevant art and will not be interpreted in an idealized or overly formal sense unless expressly so defined herein.

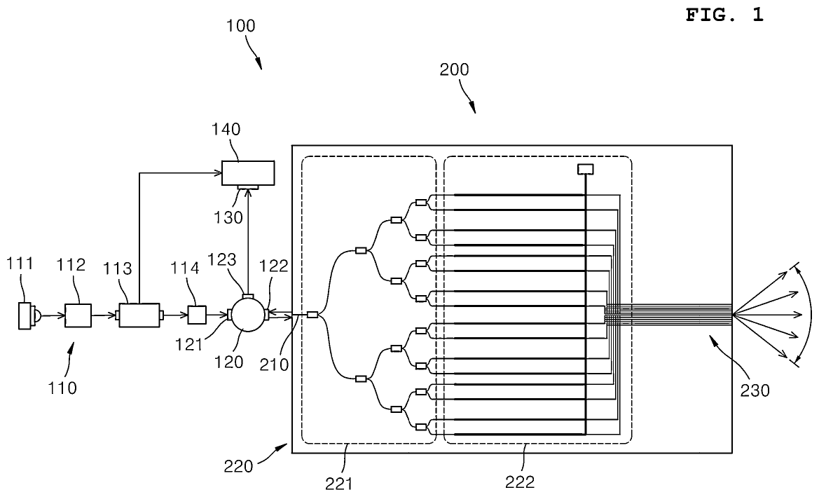

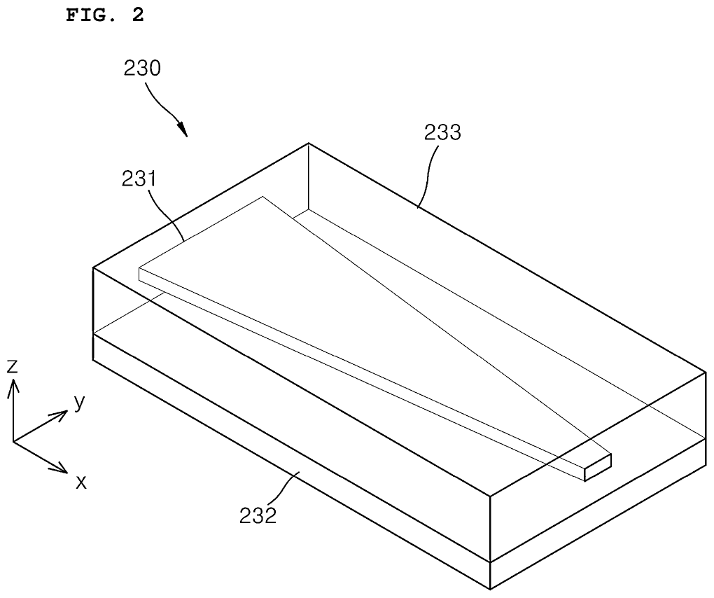

FIG. 1 is a conceptual diagram of a lidar 100 including an optical phased array antenna 200 according to the present disclosure.

Referring to the figure, a lidar 100 including an optical phased array antenna 200 according to the present disclosure includes a light source 111, an optical phased array antenna 200, an optical circulator 120, a light receiver 130, and a signal processor 140.

The light source 111 includes a laser light source 130 that generates output light, a waveform modulator 112 that modulates the waveform of output light output from the laser light source 111 into a preset waveform, a local oscillator 113 that provides a reference optical signal to the signal processor 140 by dividing a portion of the output light modulated through the waveform modulator 112, and an optical amplifier 114 that amplifies the output light that has passed through the local oscillator 113.

A laser generator that supplies a laser beam to the waveform modulator 112 is applied as the laser light source 111. The waveform modulator 112 is connected to the laser light source 112 and can change the wavelength of a laser beam generated by the laser light source 111. It is possible to rotate output light, that is, a laser beam that is output to the outside from the optical phased array antenna 200 in accordance with variation of the wavelength of the laser beam that is supplied to the optical phased array antenna 200. Since a local oscillator 113 and an optical amplifier 114 that are generally used in lidars of the related art are applied as the local oscillator 113 and the optical amplifier 114, they are not described in detail. The optical amplifier 114 is connected to the optical circulator 120 and provides output light to the optical phased array antenna 200 through the optical circulator 120.

The optical circulator 120 outputs output light input through an input terminal 121 from the light source 111 to an output terminal 122 connected to the optical phased array antenna 200 and outputs reflective light traveling back into the output terminal 122 to a detection terminal 123. The input terminal 121 of the optical circulator 120 is connected to the optical amplifier 114 of the light source 111, the output terminal 122 is connected to a combiner 210 of the optical phased array antenna 200, and the detection terminal 123 is connected to the light receiver 130.

The optical phased array antenna 200 outputs output light that is provided from the light source 111 to a measurement object and receives and transmits reflective light reflecting from the measurement object to the optical circulator 120.

The light receiver 130 receives reflective light that is output from the detection terminal 123 of the optical circulator 120. The signal processor computes detection data for the measurement object on the basis of reflective light received at the light receiver 130 and a reference optical signal that is provided from the local oscillator 113. In this case, a laser reception module constituting lidars of the related art is applied as the light receiver 130 and the signal processor, so they are not described in detail.

The optical phased array antenna 200 includes a combiner 210 that receives output light output from the light source 111 or outputs the reflective light, a phase modulation module 220 that modulates the phase of output light input from the combiner 210 or the reflective light that is transmitted to the combiner 210, an optical input/output unit 230 that outputs output light modulated by the phase modulation module 220 or receives the reflective light reflecting from the measurement object and having an antenna element waveguide 231 to which the output light or reflective light propagates and that extends a predetermined length.

The combiner 210 is connected to the output terminal 122 of the light circulator 120 and receives output light of the light source 111 through the optical circulator 120. Further, the combiner 210 outputs reflective light input to the optical input/output unit 230 and having passed through the phase modulation module 220 to the optical circulator 120.

The phase modulation module 220 includes a light distributor 221 that distributes output light propagating from the combiner 210 to a plurality of optical paths and a phase modulator 222 that modulates the phase of light distributed from the light distributor 221.

The light distributor 221 divides and transmits output light input to the combiner to a plurality of optical paths, that is, a plurality of antenna element waveguides. The light distributor 221 may be composed of a plurality of couplers. As a coupler constituting the light distributor 221, a multimode interference coupler (MMI), a Y-junction coupler, a directional coupler, or the like may be used.

The phase modulator 222 modulates the phase of the light distributed to each of the antenna element waveguides. That is, the phase of output light that is transmitted through the antenna element waveguides is modulated, so as the phase of light is modulated by the phase modulator 222, the direction of the laser beam output from the optical input/output unit 230 can be rotated about an X axis. Though not described in detail in the drawings of the present disclosure, the phase modulator 222 may be selected in the manner of being able to an electrical field by applying potential using an electrode, and accordingly, of modulating the phase of light. However, it should be noted that other than this manner, any manner can be applied as long as it modules the phase of light. A phase required for the phase modulator 222 has a type in which silicon oxide, silicon nitride, silicon oxide, and silicon are sequentially stacked from above, a silicon nitride waveguide is surrounded by the silicon oxide, and a lattice is formed by etching the upper end of the silicon nitride and the silicon oxide layer.

In this case, the silicon nitride at the upper portion has a low refractive index of about 2, so it is preferable to make the thickness as 500 m for appropriate mode confinement.

The optical input/output unit 230 is connected to the phase modulator 222 at a first end, and output light modulated by the phase modulator 220 is output to the outside through a second end of the optical input/output unit 230 or reflective light reflecting from a measurement object is input to the second end. The input reflective light is input to the output terminal 122 of the optical circulator 120 connected to the combiner 210 through the phase modulator 220. The optical input/output unit 230 includes a substrate 232, an antenna element waveguide to which output light or reflective light propagates and that extends a predetermined length in one direction (X-axial direction), and a clad layer 233 formed on the substrate 232 and formed to surround the antenna element waveguide 231.

The antenna element waveguide 231 extends a predetermined length in the traveling direction (X-axial direction of output light or reflective light. The antenna element waveguide 231 may be formed in a bra type made of silicon nitride (Si₃N₄). The antenna element waveguide 231 of the present disclosure is disposed on the substrate 232 usually called a wafer and is embedded while being surrounded by the clad layer 233 made of silicon dioxide (SiO₂). In this case, the antenna element waveguide 231 may be configured such that the height from a first end to a second end is uniform, and 0.5 μm is applied as the height. Further, 100 μm is applied as the length of the antenna element waveguide 231.

Meanwhile, antenna element waveguide 231 is formed such the width of the first end connected to the phase modulator 220 is different from the width of the second end from which output light is output or to which reflective light is input. That is, it is preferable that the antenna element waveguide 231 is formed such that the width of the second end is smaller than the width of the first end. The antenna element waveguide 231 is tapered such that the width decreases from the first end to the second end. That is, it is preferable that the antenna element waveguide 231 is formed such that the left-right (Y-axial) width decreases from the first end to the second end. In this case, 2 [symbol] is applied as the left-right width of the first end of the antenna element waveguide 231 and 0.15 [symbol] is applied as the left-right width of the second end. Meanwhile, the length, height, and width of the antenna element waveguide 231 are not limited thereto and various values may be applied in accordance with the specifications of antennas to be manufactured.

According to the optical phased array antenna 200 of the related art, the left-right (Y-axial) width of the antenna element waveguide 231 is uniform, so the transmittance of light that is output to the outside from the waveguide is low due to the difference in refractive index between the waveguide and the air, and accordingly, the discharge efficiency of output light is relatively low. Further, according to the optical phased array antenna 200 of the related art, output light partially reflects from the interface between the antenna element waveguide 231 and the air, thereby interfering with reflective light reflecting from a measurement object. Further, the divergence angle of output light is relatively large, so the image resolution of a lidar remarkably decreases.

However, since the antenna element waveguide 231 of the present disclosure is tapered, as described above, the discharge efficiency of light increases and it is also possible to reduce noise of reflective light traveling inside from the second end of the waveguide and it is also possible to achieve an effect of relatively greatly decreasing a horizontal divergence angle of a discharged signal.

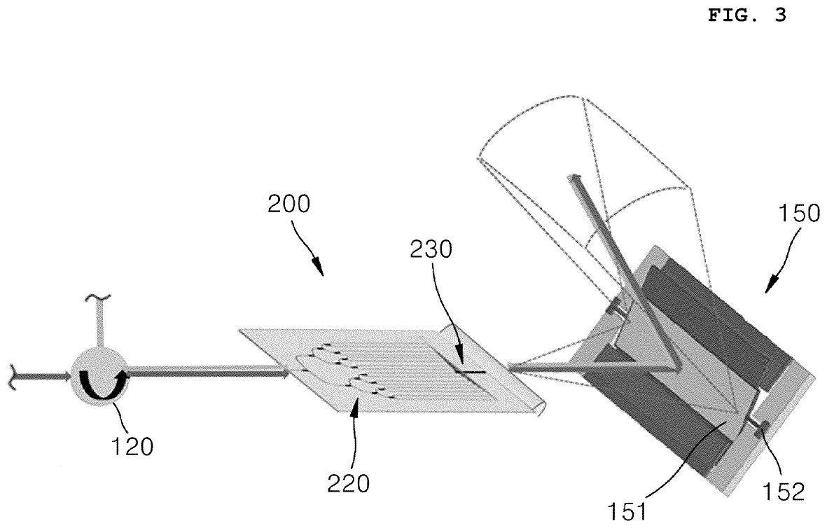

The clad layer 233 is formed to surround the antenna element waveguide 231 and is disposed on the top of the substrate 232. In this case, the clad layer 233 may support the antenna element waveguide 231 to be spaced apart upward from the substrate 232. In this configuration, the clad layer 233 is formed such that the height from the bottom thereof to the bottom of the antenna element waveguide 231 is larger than the height from the top thereof to the top of the antenna element waveguide 231. Further, it is preferable that the clad layer 233 has a width larger than the width of the antenna element waveguide 231 in the Y-axial direction. Meanwhile, the lidar 100 according to the present disclosure, as shown in FIG. 3, may further include an optical deflector 150 that is installed on the optical path of the output light, which is output from the optical phased array antenna 200, and that changes the output direction of the output light.

The optical deflector 150 includes mirror 151 that is installed on the optical path of the output light output from the optical phased array antenna 200 and reflects the output light, and a rotating member 152 that rotates the mirror 151 at a predetermined angle.

The mirror 151 is disposed on a side, that is, a reflective surface opposite to the second end of the antenna element waveguide 231 to be able to reflect output light output from the optical phased array antenna 200 or reflective light. It is preferable that the mirror 151 is formed in a rectangular shape extending a predetermined length in the left-right direction (Y-axial direction). Any driving means can be applied as the rotating member 152 as long as it supports both ends of the mirror 151 and can rotate the mirror 151. A pivotable Micro-Electro Mechanical Systems (MEMS) mirror can be applied as the optical deflector 150.

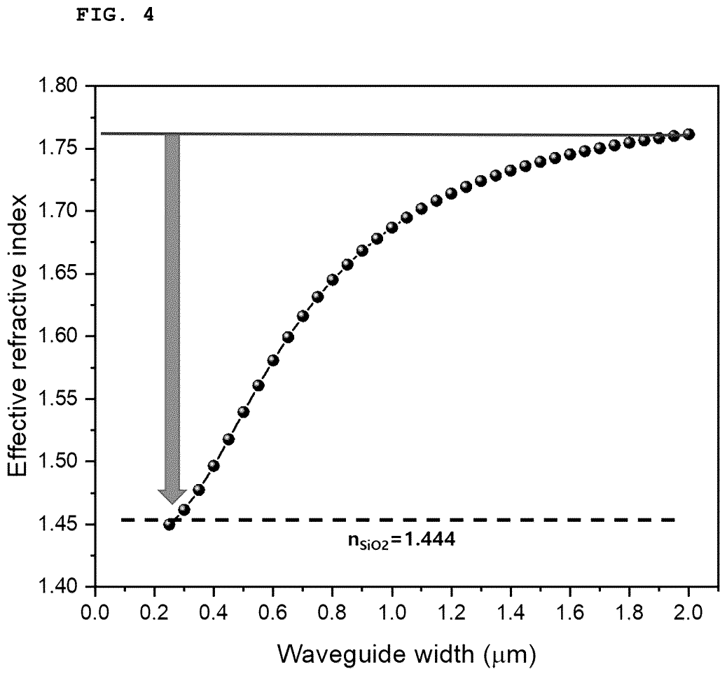

Meanwhile, a graph showing variation of an effective refractive index according to width variation of the antenna element waveguide 231 of the optical phased array antenna 200 is shown in FIG. 4. In this case, the black dotted line indicates the refractive index of air and ‘Waveguide width’ means the left-right width of the antenna element waveguide 231. Referring to the figure, the smaller the width of the antenna element waveguide 231, the more the effective refractive index decreases and the closer the effective refractive index comes to the refractive index of the air. That is, as in the present disclosure, the smaller the width of the second end of the antenna element waveguide 231 than the first end, the smaller the difference in effective refractive index between the antenna element waveguide 231 and the air, so the discharge efficiency of output light of the antenna element waveguide 231 increases.

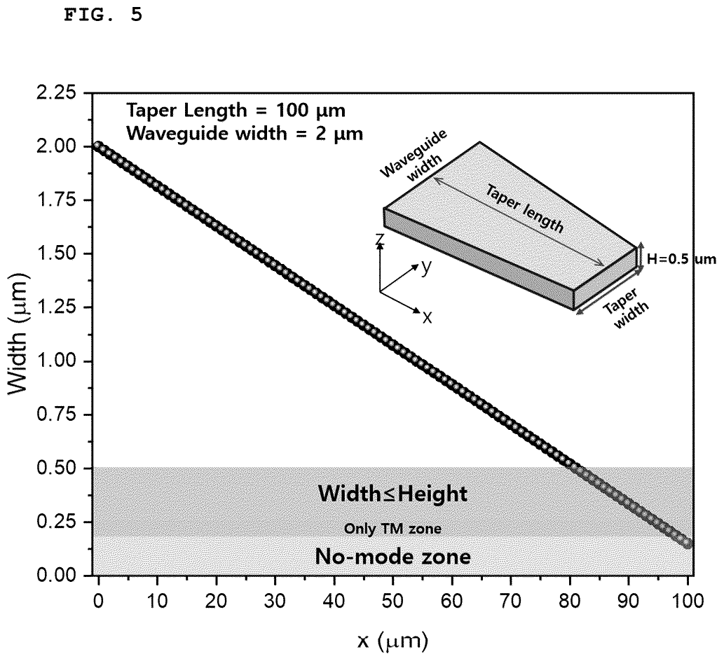

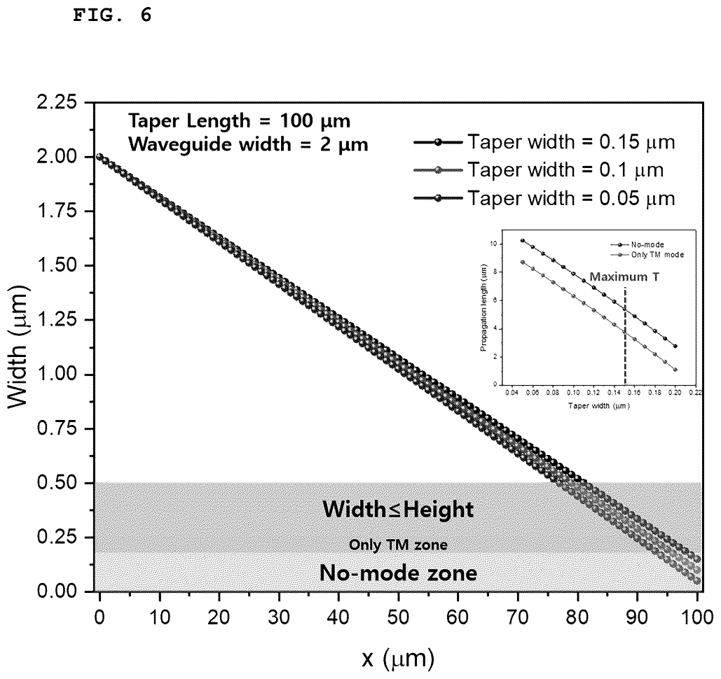

Further, graphs showing width variation of the antenna element waveguide 231 of the present disclosure according to the traveling direction of output light are shown in FIG. 5 and FIG. 6. In this case, the length of the antenna element waveguide 231 is 100 [symbol] , the height thereof is 0.5 [symbol] , and the left-right width (Waveguide width) of the first end thereof is 2 [symbol] , and x is the position moved in the traveling direction of output light from the first end of the antenna element waveguide 231. ‘only TM zone’ is an output light region in a single mode state that is available for a lidar. Further, the black graph is a graph showing an antenna element waveguide 231 having a second end left-right width (Taper width) of 0.15 [symbol] , the red graph is a graph showing an antenna element waveguide 231 having a second end left-right width (Taper width) of 0.1 [symbol] , and the blue graph is a graph showing an antenna element waveguide 231 having a second end left-right width (Taper width) of 0.05 [symbol] . Referring to the figures, it can be seen that, in the antenna element waveguide 231 having a second end left-right width (Taper width) of 0.15 [symbol] , output light at the second end (x=100 [symbol] ) reaches the single mode region.

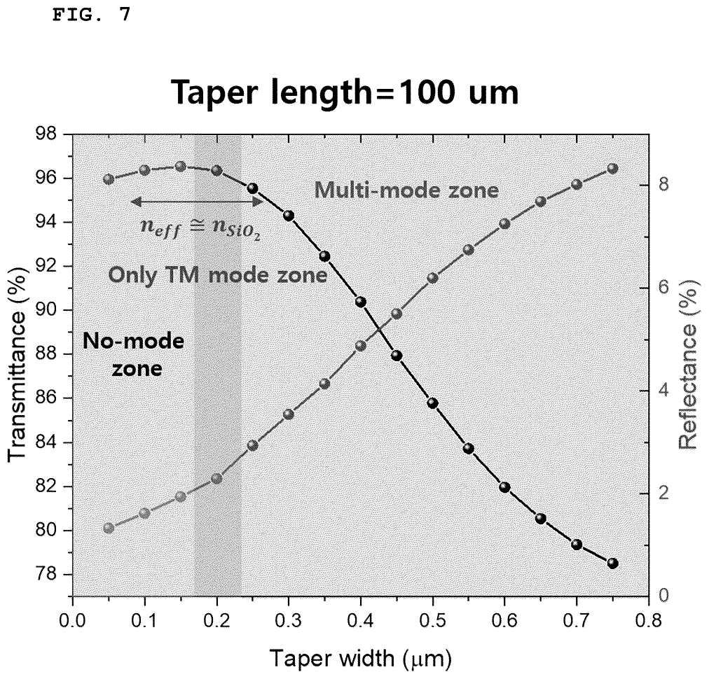

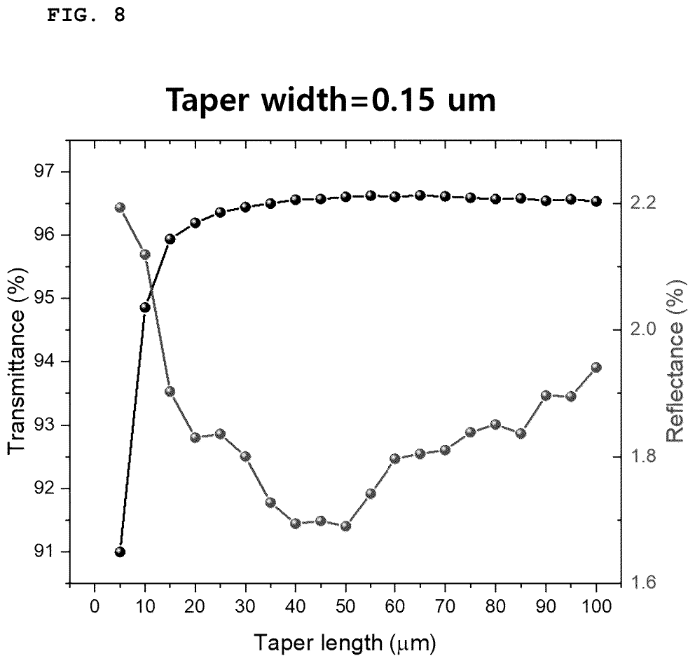

Meanwhile, a graph showing transmittance and reflectance according to the second end width of the antenna element waveguide 231 having a tapered shape is shown in FIG. 7 and a graph showing transmittance and reflectance according to the length of an antenna element having a tapered shape is shown in FIG. 8. In this case, the black graph is a graph showing transmittance, the red graph is a graph showing reflectance, and ‘only TM mode zone’ means an output light region in a single mode state that is available for a lidar. Referring to the figures, it can be seen that when the length of the antenna element waveguide 231 is 100 [symbol] and the second end width (Taper width) is 0.15 [symbol] , transmittance is relatively high and reflectance is low.

Further, the following Table 1 is a table showing transmittance and reflectance of an optical phased array antenna having an antenna element waveguide of the related art and the optical phased array antenna 200 having the antenna element waveguide 231 according to the present disclosure.

TABLE 1

| Tapering | Transmittance (%) | Reflectance (%) |
|---|---|---|
| w/o tapering | 78.31 | 12.11 |
| with tapering | 96.53 | 1.941 |

where ‘w/o tapering’ is an optical phased array antenna having an antenna element waveguide of the related and ‘with tapering’ is the optical phased array antenna 200 having the antenna element waveguide 231 of the present disclosure. Referring to Table 1, it can be seen that the optical phased array antenna 200 of the present disclosure has transmittance higher than that of the optical phased array antenna of the related art and has reflectance lower than that of the optical phased array antenna of the related art.

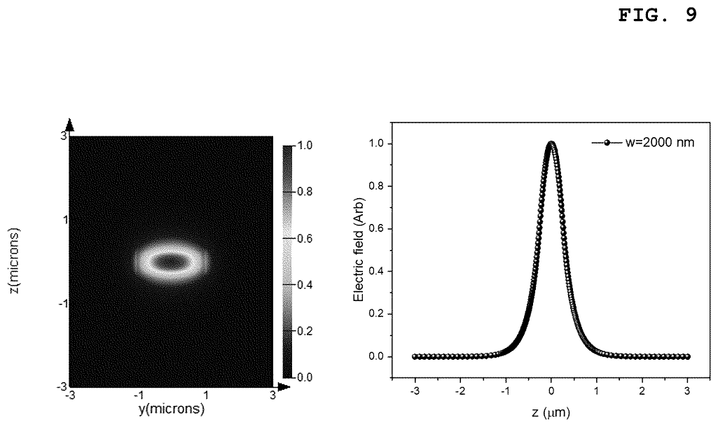

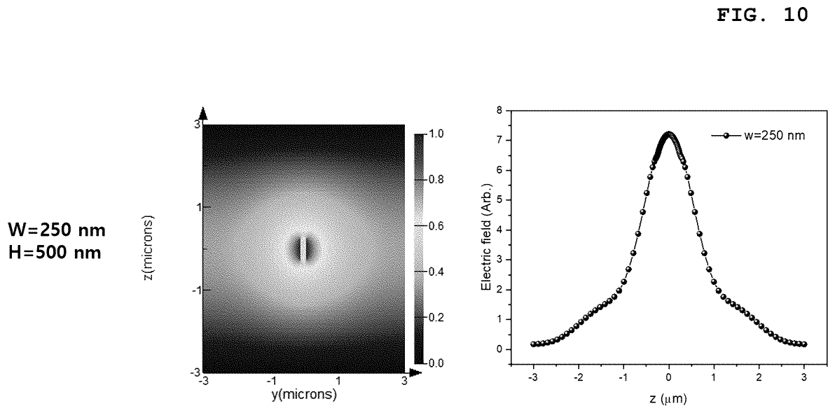

Meanwhile, a beam profile of output light that is output from an antenna element waveguide of the related art is shown in FIG. 9 and a beam profile of output light that is output from the antenna element waveguide 231 of the present disclosure is shown in FIG. 10. Referring to the figures, it can be seen that the antenna element waveguide of the related art has an elliptical beam profile of output light, but the antenna element waveguide 231 of the present disclosure has a beam profile improved into a circle of output light.

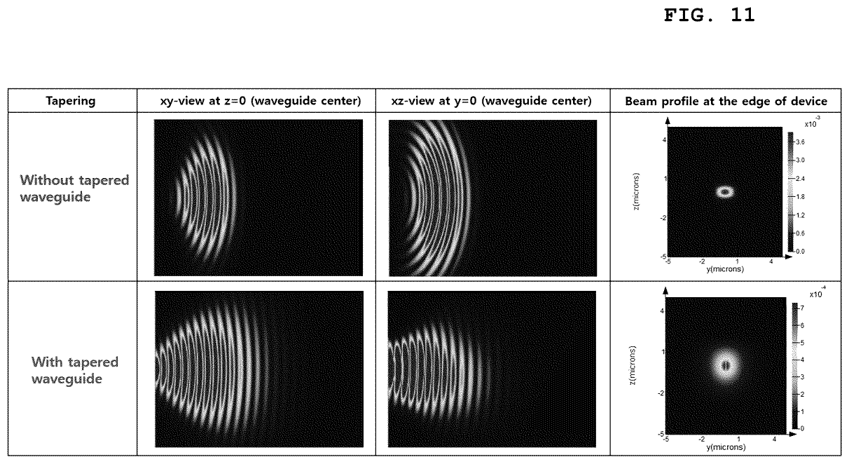

Further, the state of output light that is output from an antenna element waveguide of the related art and the state of output light that is output from the antenna element waveguide 231 of the present disclosure are shown in FIG. 11. In this case, ‘Without tapered waveguide’ means an antenna element waveguide of the related art, ‘With tapered waveguide’ means the antenna element waveguide 231 of the present disclosure, ‘xy-view at z=0’ means a beam profile of an output light in an x-y-axial direction, and ‘xz-view at y=0’ means a beam profile of an output light in an x-z-axial direction. Referring to the figure, it can be seen that the output light of the antenna element waveguide 231 of the present disclosure decreases in divergence angle lower than the output light of the antenna element waveguide of the related art, so the beam shape is improved. The following Table 2 shows that spot sizes of output light that is output from an antenna element waveguide of the related art and the antenna element waveguide 231 of the present disclosure and Table 3 shows calculated divergence angles of output light that is output from an antenna element waveguide of the related art and the antenna element waveguide 231 of the present disclosure.

TABLE 2
Obtained beam spot size at each monitors

| | | |
|---|---|---|
| | FWHM | Beam spot size |
| With or W/O tapering | (μm) | (@1/e², μm) |

| | | | | |
|---|---|---|---|---|
| w/o tapering | Near | y | 1.04 | 1.77 |
| w/o tapering | Far | y | 3.73 | 6.34 |
| w/o tapering | Near | z | 0.62 | 1.05 |
| w/o tapering | Far | z | 4.81 | 8.18 |
| with tapering | Near | y | 1.51 | 2.56 |
| with tapering | Far | y | 4.91 | 8.34 |
| with tapering | Near | z | 1.75 | 2.97 |
| with tapering | Far | z | 3.48 | 5.92 |

TABLE 3
Calculated divergence angle

| Tapering | θ_{y} (°) | θ_{z} (°) |
|---|---|---|
| w/o tapering | 24.6 | 35.5 |
| with tapering | 30.0 | 16.4 |

where ‘w/o tapering’ means an antenna element waveguide of the related art, ‘with tapering’ means the antenna element waveguide 231 of the present disclosure, θy is the divergence angle of output light in the Y-axial direction, and θz is the divergence angle of output light in the Z-axial direction. Referring to the tables, the divergence angle of the antenna element waveguide 231 of the present disclosure decreases and the beam shape is improved, it is possible to provide relatively high performance when it is applied to the lidar 100.

The description of the proposed embodiments is provided to enable those skilled in the art to use or achieve the present disclosure. Various modifications of the embodiments would be apparent to those skilled in the art, and general principles defined herein may be applied to other embodiments without departing from the scope of the present disclosure. Therefore, the present disclosure is not limited to the embodiments proposed herein and should be construed in the widest range that is consistent with the principles proposed herein and new characteristics.

What is claimed is:

1. An optical phased array antenna for a lidar that outputs output light provided from a light source to a measurement object and that receives reflective light reflecting from the measurement object, the optical phased array antenna comprising:
a combiner configured to receive output light output from the light source or to output the reflective light;
a phase modulation module configured to modulate a phase of the output light input from the combiner or the reflective light that is transmitted to the combiner; and
an optical input/output unit configured to output the output light modulated by the phase modulation module or receive the reflective light reflecting from the measurement object and configured to have an antenna element waveguide to which the output light or the reflective light propagates and that extends a predetermined length,
wherein antenna element waveguide is formed such a width of a first end connected to the phase modulator is different from a width of a second end from which the output light is output or to which the reflective light is input.

2. The optical phased array antenna of claim 1, wherein the antenna element waveguide is formed such that the width of the second end is smaller than the width of the first end.

3. The optical phased array antenna of claim 1, wherein the antenna element waveguide is tapered such that the width decreases from the first end to the second end.

4. The optical phased array antenna of claim 3, wherein the optical input/output unit further comprises:
a substrate; and
a clad layer formed on the substrate and formed to surround the antenna element waveguide.

5. The optical phased array antenna of claim 4, wherein the antenna element waveguide is formed such that a left-right width decreases from the first end to the second end.

6. The optical phased array antenna of claim 5 wherein the antenna element waveguide has a uniform height.

7. The optical phased array antenna of claim 3, wherein the phase modulation module comprises:
a light distributor configured to distribute output light propagating from the combiner to a plurality of optical paths; and
a phase modulator configured to modulate a phase of light distributed from the light distributor.

8. A lidar comprising:
a light source;
an optical phased array antenna of claim 1;
an optical circulator configured to output output light input through an input terminal from the light source to an output terminal connected to the optical phased array antenna and configured to output reflective light traveling back into the output terminal to a detection terminal;
a light receive configured to receive reflective light output from the detection terminal; and
a signal processor configured to process a signal received at the light receiver.

9. The lidar of claim 8, further comprising an optical deflector installed on an optical path of output light, which is output from the optical phased array antenna, and change an output direction of the output light.

10. The lidar of claim 9, wherein the optical deflector comprises: a mirror installed on the optical path of the output light output from the optical phased array antenna and to reflect the output light; and a rotating member configured to rotate the mirror at a predetermined angle.

11. The lidar of claim 9, wherein the optical reflector comprises a pivotable MEMS mirror.
